(19) United States
(12) Patent Application Publication
(10) Pub. No.: US 2018/0018803 A1
(43) Pub. Date: Jan. 18, 2018

(54) AUTOMATICALLY GENERATING ACTOR PERFORMANCES FOR USE IN AN ANIMATED MEDIUM

(71) Applicant: Telltale, Incorporated, San Rafael, CA (US)

(72) Inventors: Kevin Bruner, San Rafael, CA (US); Zacariah Litton, San Pablo, CA (US)

(21) Appl. No.: 15/209,395

(22) Filed: Jul. 13, 2016

(51) Int. Cl. G06T 13/40; G06F 17/27

(52) U.S. Cl. CPC G06T 13/40; G06F 17/2705

(57) ABSTRACT

Techniques for generating CG actor performances for use in an animated medium are provided. In one embodiment, a computer system can receive (1) a textual script of a scene in which a CG actor appears, and (2) a style guide for the CG actor that includes information regarding personality traits and physical mannerisms of the CG actor. The computer system can then automatically generate a performance for the CG actor based on the textual script and the style guide.

### BACKGROUND

Many works of animated media produced today make use of computer-generated imagery and more particularly, computer-generated actors, to present a narrative to an audience. Examples of computer-generated actors include Gollum from the “Lord of the Rings” series of films and Sam & Max from their eponymous series of adventure video games.

Conventionally, the task of animating a computer-generated, or CG, actor requires one or more animators to design by hand the actor's poses, body movement, gestures, facial expressions, lip/mouth synching, and so on for each scene in which the actor appears. For works of animated media that rely heavily on CG actors, this can be an extremely laborious and time-consuming process. Accordingly, it would desirable to have techniques that can enable media production teams to more quickly and efficiently create CG actor performances/animations.

### SUMMARY

Techniques for generating CG actor performances for use in an animated medium are provided. In one embodiment, a computer system can receive (1) a textual script of a scene in which a CG actor appears, and (2) a style guide for the CG actor that includes information regarding personality traits and physical mannerisms of the CG actor. The computer system can then automatically generate a performance for the CG actor based on the textual script and the style guide.

The following detailed description and accompanying drawings provide a better understanding of the nature and advantages of particular embodiments.

### BRIEF DESCRIPTION OF DRAWINGS

FIG. 1 depicts a system environment according to an embodiment.

FIGS. 2, 3, and 4 depict workflows for automatically generating CG actor performances according to an embodiment.

FIG. 5 depicts an example computing device/system according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

### 1. Overview

Embodiments of the present disclosure describe a tool (referred to herein as the “actor performance generator,” or APG) that automatically generates CG actor performances for use in an animated medium such as a video game, a television program, or a feature film. In one set of embodiments, APG can receive a textual script of a scene involving at least one CG actor and style information (i.e., a “style guide”) associated with that actor. For example, the style guide can include information regarding the CG actor's character traits and/or physical mannerisms (e.g., habits and behaviors). APG can then procedurally generate, based on the textual script and the style guide, a set of animations (collectively referred to as a “performance”) for the CG actor that enables the actor to act out his/her part in the scene.

With APG, a number of advantages can be realized over conventional animation techniques. First, since actor performances are generated automatically by APG using the style guides and scene scripts as inputs, there is no need to manually animate each actor on a per-scene basis. As a result, the amount of time and effort needed to produce works of animated media that include CG actors can be significantly reduced. Although there is some manual effort involved in defining the style guide for a given CG actor, once the style guide is created it can be reused for multiple scenes/scripts in which that actor appears. Accordingly, APG is particularly useful for reducing the amount of time and effort needed to animate “lead” CG actors that appear in a large number of scenes within a work (or across related works such as a series).

Second, since APG is a computer-driven tool that relies on a CG actor's style guide as the basis for creating the actor's animations, APG can, in some situations, produce more consistent performances for that actor than traditional hand-designed animation. For example, consider a scenario where CG actor A appears in scenes S1, S2, and S3, and a separate animator is tasked with manually animating A in each respective scene. In this case, even if the animators are provided with the same directions regarding A's mannerisms, character traits, etc., the individual artistic preferences and tendencies of each animator may cause A's animations to differ in S1-S3, thereby resulting in an uneven portrayal of A. This problem is largely avoided by using APG, which can apply A's style guide in an algorithmically consistent fashion to any scene in which A appears.

In some embodiments, APG can be used to generate CG actor performances for a work of animated media that is pre-rendered, such as a pre-rendered television program, feature film, cut-scene, trailer, etc. In these embodiments, APG may be run on a development system during the production process and a user of that system may generate multiple candidate performances for a given CG actor and scene via APG. The user may then choose (and optionally tweak by hand) the candidate performance that the user feels best captures the CG actor's personality for inclusion in the final version of the work.

In other embodiments, APG can be used to generate CG actor performances for a work of animated media that is rendered in real-time (i.e., at the point of presentation to its audience), such as a video game. In these embodiments, there are two possible use cases. According to one use case, APG can be run on a development system (in a manner similar to the pre-rendered context above) to create a fixed set of animations for a CG actor that will be rendered in real-time on a media presentation device (e.g., a video game console). According to another use case, APG can be run on the media presentation device itself to generate CG actor performances “on-the-fly” as a scene is being rendered. In this second use case, due to the procedural nature of APG, the CG actor performances that the audience sees may differ slightly from one viewing to another, but should remain true to the “character” of each actor.

The foregoing and other aspects of the present disclosure are described in further detail in the sections that follow.

### 2. System Environment

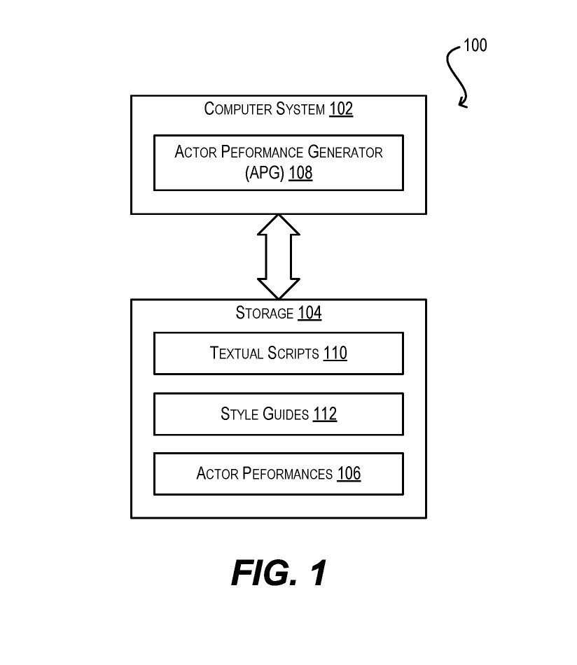

FIG. 1 depicts a system environment 100 in which embodiments of the present disclosure may be implemented. As shown, system environment 100 includes a computing device/system 102 that is communicatively coupled with a storage component 104. Computing device/system 102 can be any conventional device/system known in the art, such as a desktop system, a laptop, a server system, a video game console, or the like. Storage component 104 can be a component that is located remotely from computing device/system 102 such as a networked storage array, or locally attached to computing device/system 102 such as a commodity magnetic or solid-state hard disk.

In the example of FIG. 1, computing device/system 102 is used to create sets of animations (i.e., performances) 106 for CG actors in an animated medium. For instance, computing device/system 102 may be a development system that is used during the production of a particular video game, television program, or feature film. Once created, these CG actor performances 106 can be stored on storage component 106 and applied to animate the respective CG actors that appear in that video game/television program/film.

As noted the Background section, conventional techniques for creating CG actor performances are typically time-consuming and labor-intensive because they require a large amount of manual design and effort. This is particularly problematic for works of computer-animated media that are heavily focused on narrative development and presentation, since such works often include a significant number of scenes involving CG actors.

To address these and other similar issues, computing device/system 102 of FIG. 1 includes a novel actor performance generator tool, or APG, 108. APG 108 can be implemented in software, hardware, or a combination thereof. As discussed in further detail below, APG 108 can be used to generate CG actor performances in an automated (or semi-automated) manner based on scene scripts and actor style information that are provided as inputs (e.g., scripts 110 and style guides 112 shown in storage component 104). With this tool, media production teams can advantageously accelerate and simplify their animation creation workflows.

It should be appreciated the system environment 100 of FIG. 1 is illustrative and various modifications are possible. For example, the various components shown in system environment 100 can be arranged according to different configurations and/or include subcomponents/functions not specifically described. One of ordinary skill in the art will recognize many variations, modifications, and alternatives.

### 3. Workflows

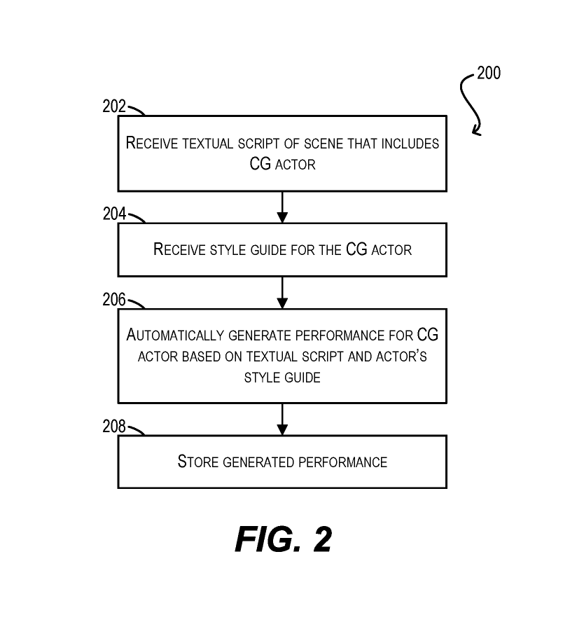

FIG. 2 depicts a workflow 200 that may be executed by APG 108 of FIG. 1 for automatically generating CG actor performances according to an embodiment. Starting with block 202, APG 108 can receive a textual script of a scene to be included in a work of computer-animated media (e.g., a video game, television program, feature film, etc.). In various embodiments, the textual script can comprise dialogue that is spoken by one or more CG actors in the scene. The textual script can also comprise other scene-related information, such as descriptors/cues indicating each actor's general temperament, position in the scene, movement, etc. as the actor's speaks his/her dialogue lines (e.g., “A appears angry” or “A walks toward the door while mumbling ‘xyz . . . ’”).

At block 204, APG 108 can receive a style guide for a particular CG actor (e.g., actor A) that appears in the scene. Generally speaking, the style guide can include information regarding the character traits (e.g., cheery, sullen, etc.) and/or physical mannerisms (e.g., typical poses, gestures, facial expressions, eye movements, etc.) exhibited by actor A. These pieces of information may be associated with certain descriptors/cues or dialog categories that appear in the script. For example, the style guide may include representative gestures or facial expressions that are exhibited by actor A when he is angry, or when he speaks dialogue lines that fall into a particular category such as “question” or “request.”

In one set of embodiments, the information included in the style guide can be limited to a predefined set of human-readable parameters (e.g., a predefined set of character traits, a predefined set of gestures, etc.). This can allow users without animation expertise to define and edit the style guide. In other embodiments, the style guide can (in addition to or lieu of the above) incorporate more technical information such as animation key frames, key poses, etc.

Once APG 108 has received the scene script and actor A's style guide, APG 108 can apply these inputs to automatically generate an actor performance for A (block 206). This step can include the sub-steps of, e.g., parsing the contents of the scene script and the style guide, determining associations between the various elements in those two documents (e.g., associations between the dialogue in the scene script and mannerisms in the style guide), and then procedurally creating, based on those associations, an appropriate set of animations that allow A to “act out” the scene in a manner that is suited to his/her intended personality. As used here, the term “procedurally” means that the set of animations is created using a computer algorithm, with an aspect of randomness (such that two output performances based on the same inputs will generally be slightly different). In a particular embodiment, APG 108 can create the set of animations purely procedurally, such that APG 108 does not rely on any predesigned animation data. In other embodiments, APG 108 can create the set of animations by procedurally merging and/or modifying one or more predesigned “base” animations that are included in the style guide.

Finally, upon generating the performance for actor A at block 206, APG 108 can store the generated performance data in, e.g., storage component 104 for downstream use (e.g., at the point of rendering the scene) (block 208).

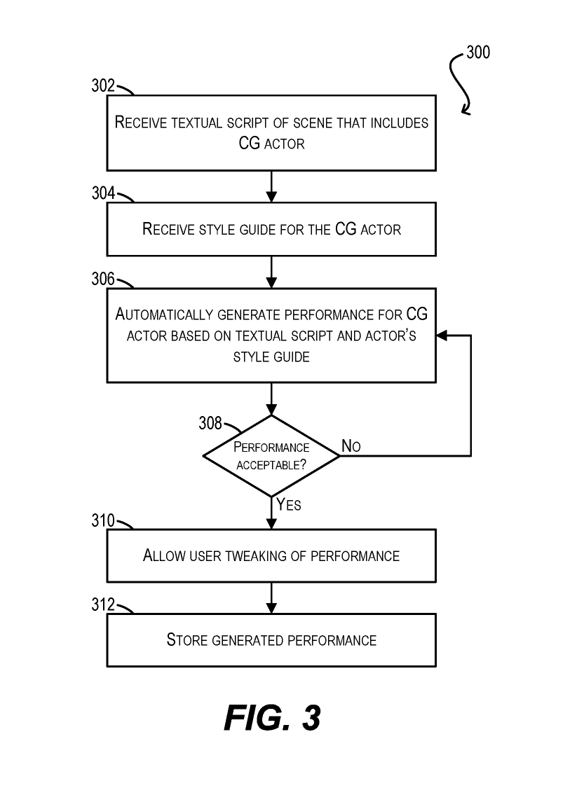

As mentioned previously, in certain embodiments, APG 108 can be used to generate CG actor performances that are fixed, or predetermined, at the time of production. These fixed performances can be used in pre-rendered works (e.g., pre-rendered television programs, feature films, cut-scenes, etc.) or real-time rendered works (e.g., real-time rendered video games). In these embodiments, the computing device/system on which APG 108 runs may be a development system, and a user of that system may generate multiple candidate performances for a given CG actor and scene via APG 108 in order to arrive at a performance that the user feels best captures the CG actor's personality for inclusion in the final version of the work. An example of this process is shown in FIG. 3 as workflow 300. Blocks 302-306 of workflow 300 are substantially similar to blocks 202-206 of workflow 200; however, at block 308, the user of the system can evaluate the actor performance generated by APG 108 at block 306 (by, e.g., running the animations included in the performance on a model of the actor). If the user is satisfied with the generated performance, the user can optionally tweaks aspects of the performance by hand (block 310) and then save the performance to storage component 104 (block 312). If the user is not satisfied with the generated performance, the user can re-run APG 108 using the same inputs (i.e., the scene script and the actor style guide), and this process can be repeated until the user determines that APG 108 has generated an acceptable performance.

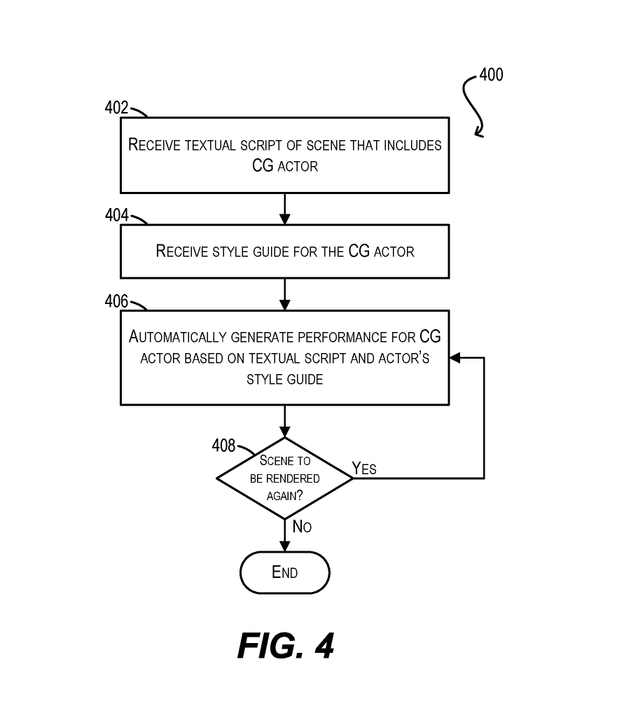

In certain other embodiments, APG 108 can be used to generate CG actor performances “on-the-fly” at the time of rendering a scene. This approach can be used in real-time rendered works such as real-time rendered video games. In these embodiments, the computing device/system on which APG 108 runs may be an end-user media presentation device (e.g., a video game console), and APG 108 can dynamically re-generate an actor performance within a given scene each time that scene is presented/rendered. An example of this process is shown in FIG. 4 as workflow 400. Blocks 402-406 of workflow 400 are substantially similar to blocks 202-206 of workflow 200; however, at block 408, a determination can be made whether the same scene needs to be rendered again (for example, the video game level in which the scene appears may be restarted). If so, APG 108 can repeat block 406 for the next rendering of the scene. Otherwise, workflow 400 can end. Note that, with this approach, the actor performance that the end-user sees may differ slightly from one presentation/rendering of the scene to another due to the procedural nature of APG 108. But, since APG 108 relies on the actor's style guide to generate its animations, each performance should remain true to the personality of the actor as defined in the style guide.

### 4. Example Computing Device/System

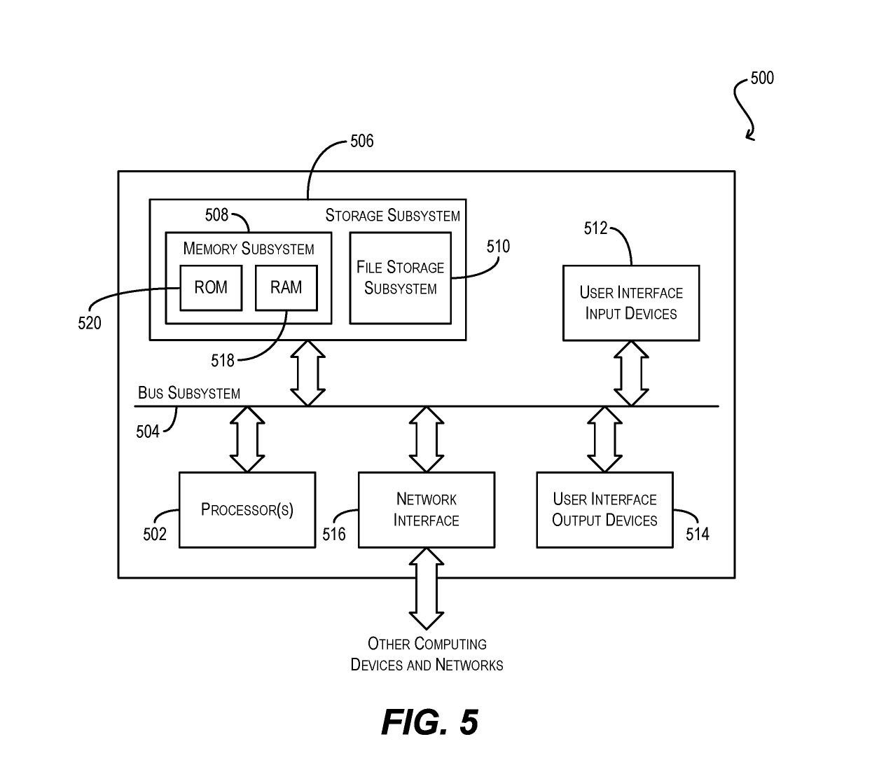

FIG. 5 depicts an example computing device/system 500 according to an embodiment. Computing device/system 500 may be used to implement, e.g., device/system 102 described in the foregoing sections.

As shown, computing device/system 500 can include one or more processors 502 that communicate with a number of peripheral devices via a bus subsystem 504. These peripheral devices can include a storage subsystem 506 (comprising a memory subsystem 508 and a file storage subsystem 510), user interface input devices 512, user interface output devices 514, and a network interface subsystem 516.

Bus subsystem 504 can provide a mechanism for letting the various components and subsystems of computing device/system 500 communicate with each other as intended. Although bus subsystem 504 is shown schematically as a single bus, alternative embodiments of the bus subsystem can utilize multiple busses.

Network interface subsystem 516 can serve as an interface for communicating data between computing device/system 500 and other computing devices or networks. Embodiments of network interface subsystem 516 can include wired (e.g., coaxial, twisted pair, or fiber optic Ethernet) and/or wireless (e.g., Wi-Fi, cellular, Bluetooth, etc.) interfaces.

User interface input devices 512 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and other types of input devices. In general, use of the term “input device” is intended to include all possible types of devices and mechanisms for inputting information into computing device/system 500.

User interface output devices 514 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computing device/system 500.

Storage subsystem 506 can include a memory subsystem 508 and a file/disk storage subsystem 510. Subsystems 508 and 510 represent non-transitory computer-readable storage media that can store program code and/or data that provide the functionality of various embodiments described herein.

Memory subsystem 508 can include a number of memories including a main random access memory (RAM) 518 for storage of instructions and data during program execution and a read-only memory (ROM) 520 in which fixed instructions are stored. File storage subsystem 510 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computing device/system 500 is illustrative and not intended to limit embodiments of the present disclosure. Many other configurations having more or fewer components than computing device/system 500 are possible.

The above description illustrates various embodiments of the present disclosure along with examples of how certain aspects may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
receiving, by a computer system, a textual script of a scene in which a computer-generated (CG) actor appears;
receiving, by the computer system, a style guide for the CG actor that includes information regarding personality traits and physical mannerisms of the CG actor; and
automatically generating, by the computer system, a performance for the CG actor based on the textual script and the style guide.

2. The method of claim 1 wherein the performance comprises a set of animations for animating the CG actor within the scene.

3. The method of claim 1 wherein the textual script includes dialogue spoken by the CG actor and one or more descriptors or cues regarding the CG actor's general temperament or position in the scene.

4. The method of claim 1 wherein the style guide comprises a predefined set of human-readable parameters.

5. The method of claim 1 wherein the style guide comprises animation key frames or key poses.

6. The method of claim 1 wherein automatically generating the performance for the CG actor comprises:
parsing the textual script and the style guide;
determining associations between elements in the textual script and the style guide; and
procedurally generating a set of animations based on the determined associations.

7. The method of claim 1 wherein the automatically generating is performed during a production phase for a work of animated media that includes the scene.

8. The method of claim 1 wherein the automatically generating is performed at a point of rendering the scene in real-time for an end-user audience.

9. A non-transitory computer readable storage medium having stored thereon program code executable by a computer system, the program code causing the computer system to:
receive a textual script of a scene in which a computer-generated (CG) actor appears;
receive a style guide for the CG actor that includes information regarding personality traits and physical mannerisms of the CG actor; and
automatically generate a performance for the CG actor based on the textual script and the style guide.

10. The non-transitory computer readable storage medium of claim 9 wherein the performance comprises a set of animations for animating the CG actor within the scene.

11. The non-transitory computer readable storage medium of claim 9 wherein the textual script includes dialogue spoken by the CG actor and one or more descriptors or cues regarding the CG actor's general temperament or position in the scene.

12. The non-transitory computer readable storage medium of claim 9 wherein the style guide comprises a predefined set of human-readable parameters.

13. The non-transitory computer readable storage medium of claim 9 wherein the style guide comprises animation key frames or key poses.

14. The non-transitory computer readable storage medium of claim 9 wherein the program code that causes the computer system to automatically generate the performance for the CG actor comprises program code that causes the computer system to:
parse the textual script and the style guide;
determine associations between elements in the textual script and the style guide; and
procedurally generate a set of animations based on the determined associations.

15. The non-transitory computer readable storage medium of claim 9 wherein the automatically generating is performed during a production phase for a work of animated media that includes the scene.

16. The non-transitory computer readable storage medium of claim 9 wherein the automatically generating is performed at a point of rendering the scene in real-time for an end-user audience.

17. A computer system comprising:
a processor; and
a memory having stored thereon program code that, when executed by the processor, causes the processor to:
receive a textual script of a scene in which a computer-generated (CG) actor appears;
receive a style guide for the CG actor that includes information regarding personality traits and physical mannerisms of the CG actor; and
automatically generate a performance for the CG actor based on the textual script and the style guide.

18. The computer system of claim 17 wherein the performance comprises a set of animations for animating the CG actor within the scene.

19. The computer system of claim 17 wherein the textual script includes dialogue spoken by the CG actor and one or more descriptors or cues regarding the CG actor's general temperament or position in the scene.

20. The computer system of claim 17 wherein the style guide comprises a predefined set of human-readable parameters.

21. The computer system of claim 17 wherein the style guide comprises animation key frames or key poses.

22. The computer system of claim 17 wherein the program code that causes the processor to automatically generate the performance for the CG actor comprises program code that causes the processor to:
parse the textual script and the style guide;
determine associations between elements in the textual script and the style guide; and
procedurally generate a set of animations based on the determined associations.

23. The computer system of claim 17 wherein the automatically generating is performed during a production phase for a work of animated media that includes the scene.

24. The computer system of claim 17 wherein the automatically generating is performed at a point of rendering the scene in real-time for an end-user audience.
